(19) United States
(12) Patent Application Publication
(10) Pub. No.: US 2012/0213980 A1
(43) Pub. Date: Aug. 23, 2012

(54) METHOD FOR THE SELF-ASSEMBLY OF ELECTRICAL, ELECTRONIC OR MICROMECHANICAL COMPONENTS ON A SUBSTRATE

(76) Inventors: Volker Arning, Dusseldorf (DE); Jürgen Steiger, Dusseldorf (DE); Ingo Schoenemann, Mulheim an der Ruhr (DE); Arne Hoppe, Herne (DE)

(21) Appl. No.: 13/503,789

(22) PCT Filed: Oct. 5, 2010
(86) PCT No.: PCT/EP2010/064782

§ 371 Date: Apr. 24, 2012

(30) Foreign Application Priority Data
Oct. 26, 2009 (DE) 10 2009 050 703.5

(51) Int. Cl. B32B 3/10; B32B 38/00; B32B 37/12

(52) U.S. Cl. 428/201; 156/289; 156/227

(57) ABSTRACT

A method for the self-assembly of at least one electrical, electronic or micromechanical component on a substrate, including the steps of: a) providing the substrate, b) applying an adhesive-repelling composition to at least one partial surface of the substrate which does not constitute a target position of the component, followed by a curing step, c) applying an adhesive composition to at least one partial surface of the substrate which constitutes a target position of the component, the partial surface of the substrate which is provided with the adhesive-repelling composition enclosing and adjoining the partial surface of the substrate which is provided with the adhesive composition, and d) applying at least one component to a partial surface coated in accordance with b) or c), in which method the adhesive-repelling composition is a radiation-curing abhesive coating compound, and to an electrical or electronic product which can he produced according to the method.

The present application claims priority from PCT Patent Application No. PCT/EP2010/064782 filed on Oct. 5, 2010, which claims priority from German Patent Application No. DE 10 2009 050 703.2 filed on Oct. 26, 2009, the disclosures of which are incorporated herein by reference in their entirety.

### BACKGROUND OF THE INVENTION

### Field of the Invention

The invention relates to a method for the self-assembly of electrical, electronic or micromechanical components on a substrate.

It is noted that citation or identification of any document in this application is not an admission that such document is available as prior art to the present invention.

Advanced semiconductor technology makes it possible to realize the technical solution to many different electrical, electronic or logical problems, such as, for example, problems relating to the signal processing or the storage of information, in small components in a very confined space. In the course of general miniaturization the part played by micromechanical components, too, is becoming more and more important. A component within the meaning of this invention is a, in particular small, building block which can be used in technical products and which can fulfil a technical function which, however, becomes technically usable only in association with other structures. In this case, electrical, electronic or micromechanical components should be understood to mean, in particular, the group of elements comprising integrated circuits, signal processing elements, diodes, memories, driving electronics (in particular for displays), sensors (in particular for light, heat, concentration of substances, moisture), electro-optical or electroacoustic elements, radio-frequency identification chips (RFID chips), semiconductor chips, photovoltaic elements, resistors, capacitors, power semiconductors (transistors, thyristors, TRIACs) and/or light-emitting diodes (LEDs).

For the use of the components, the latter in each case have to be transferred, with the formation of electrical or electronic devices or intermediate products, to substrates, for example printed circuit boards or a structured film, with the production of a larger technically functional unit.

These electrical or electronic products, which means the electrical or electronic devices and intermediate products, have the electrical, electronic or micro-mechanical components provided with contact-connection on a substrate. The electrical or electronic products enable the electrification, functionalization, control and/or reading of the electrical, electronic or micromechanical components. Furthermore, they actually enable, if necessary, their further incorporation or their contact-connection in the respective end products, e.g. by means of plug connections (in particular USB terminals) or by connection to power supply units or cable-based networks.

A multiplicity of products can be used as substrates. Thus, electrical, electronic or micromechanical components can be applied on polymeric or metallic carrier substrates. In this case, the carriers can be flexible or rigid. The electrical, electronic or micromechanical components are often applied to film substrates. The substrate often consists of electrically conductive structures (e.g. structured metals or conductor tracks, if appropriate themselves in turn on a non-conductive, in particular polymeric, carrier material). These can serve for making contact with the components, but also, as e.g. in the case of an RFID label, as an antenna.

Examples of the electrical or electronic products include RFID straps, RFID labels, populated printed circuit boards, such as occur in almost all electrical apparatuses, thus for example in mobile telephones, computers, computer mouses, pocket calculators, remote controls, but also in comparatively simple elements such as USB flash memories, SIM cards, smart cards, clocks and alarm clocks.

For the production of the electrical or electronic products, the positioning of the respective electrical, electronic or micromechanical components on the substrate is of great importance since only a precise positioning of a component also subsequently enables correct contact-connection thereof and hence also a correct functioning of the respective product.

At the present time, components are positioned on the substrates primarily by means of “pick and place” robots. However, this complex mechanical regulation of the positioning process is inevitably limited with regard to the attainable speed of the process on account of the high precision required in this case. Furthermore, this method procedure has the disadvantage that small components, in particular, due to their small mass in comparison to the increasingly important electrostatic and capillary forces, have the tendency to stick to the mechanical parts.

One alternative to these “pick and place” methods is the method described in U.S. Pat. No. 5,355,577 A for the assembly of microelectronic or micromechanical components on a planar template, in which the components are placed on the template and the template is shaken, as a result of which the components, supported by an applied voltage, accumulate in openings embodied in a manner corresponding to the form of said components on the template. This method is also disadvantageous, however, since it requires a high technical complexity and, for example, canting of the components in the openings during the shaking process can lead to erroneous assembly.

Various methods based on self-assembly of the components to be positioned are proposed in order to overcome these disadvantages. What is common to all these methods is that an energetically inhomogeneous surface is created on the substrate, on which surface the subsequently applied components orient themselves at the location of the lowest energy.

Thus, U.S. Pat. No. 6,507,989 B1, for example, teaches a method for the self-assembly of components on structurally or otherwise adapted surfaces with the formation of composite materials, in which the affected surfaces are chemically modified for better wetting. In this case, the self-assembly can be performed for example by means of effects such as adhesion and/or a reduction of the free surface energy. One self-assembly technique described therein consists in bringing together specific contact surfaces of the components by utilizing interface effects in a system of two mutually incompatible liquids (e.g. water and perfluorodecalin). What is disadvantageous in this case, however, is that the assembly rate correlates directly with the sizes of the contact surfaces. Moreover, the necessary performance of the method in liquid mixtures is disadvantageous for constituent parts which cannot be processed in liquids. A similar process is described in WO2007/037381 A1 (=US 2009/0265929 A1) where a self assembly mechanism is based on two liquids, while no reference to using an adhesive is made.

U.S. Pat. No. 3,869,787 A describes a non-wettable substrate, and a chip, which is wettable only at one side by fluids or waxes, and can be used to self assemble the chip based on surface energy. The component, for example an electronic chip, has to be manufactured to be wettable only at the backside by the fluid used for self assembly. There is no reference in this teaching that a radiation curing abhesive coating can be used.

The U.S. Pat. No. 4,199,649 deals with manufacturing an abhesive surface for various applications and mentions radiation curing, but does not mention self assembly of an electrical part.

U.S. Pat. No. 6,623,579 B1 describes methods for the assembly of a multiplicity of elements on a substrate, in which a slurry of the elements in a fluid is directed onto the substrate and the substrate has receptor regions forming cutouts for the elements, the elements accumulate in the cutouts, and excess elements not taken up are led away after a vibration process. These methods represents a fluidic self-assembly method in which the elements to be assembled are dispersed in a fluid and directed over the surface. This method also has the disadvantage, however, that constituent parts which are not compatible with the fluids used cannot be processed. Furthermore, it is disadvantageous that, in such methods, it is generally necessary to use an excess of elements compared with the number of assembly locations on the substrate.

Xiong et al. (“Controlled part-to-substrate Micro-Assembly via electrochemical modulation of surface energy”, Transducers '01—International Conference on solid-State Sensors and Actuators, Munich, Germany, 2001) teaches micro-assembly methods in which assembly locations between microcomponents and substrates are set in a targeted manner with regard to their hydrophobicity. In this case, active assembly locations on the microcomponent or substrate are hydrophobic surfaces composed of alkanethiol-coated gold, wherein inactive assembly locations consist of pure, hydrophilic gold surfaces. In this case, the active assembly locations can be converted into inactive, hydrophilic gold surfaces by electrochemical reduction of the alkanethiolate monolayers. If a hydrocarbon-based “lubricant” is applied to the surfaces and components and substrate are then dipped into water, it wets only the hydrophobic assembly locations, reduces the friction there and makes it possible, in a manner supported by capillary forces, that microcomponents can be attached on the specific location on the substrate. In that case, too, there is the disadvantage, however, that the components and the substrates necessarily have to be resistant to water. Furthermore, they are disadvantageously restricted in their configuration since they have to have gold surfaces. Furthermore, in that case, too, there is the disadvantage that, in order to achieve good results, it is necessary to use an excess of elements compared with the number of assembly locations on the substrate.

Self-assembly processes that take place in a dry environment are taught by S. Park and K. F. Böhringer, “A fully dry self-assembly process with proper in-plane orientation”, MEMS '08, Tucson, Ariz., US, 2008, substrate and elements to be assembled thereon having complementary meshing features. In order to achieve a uniform orientation of the elements assembled on the substrate, the elements and the substrate furthermore have secondary features that support the uniform orientation. In order to achieve assembly; the substrate with the elements situated thereon is vibrated until the primary and secondary features mesh. The method described there has the disadvantage, however, that the requisite modification of the components and the assembly per se are very complex.

WO 2003/087590 A2 describes methods for the self-assembly of structures in which a liquid is applied to a substrate in patterned fashion and then, while at least a portion of the liquid remains in liquid form, at least a portion of the structures self-assembles on account of interactions with the liquid in accordance with its patterning on the substrate after its application. The liquid used can be, for example, liquid soldering tin, an adhesive, an epoxy resin or a prepolymer. In order to facilitate the patterning of the liquid on the substrate, a precursor that exhibits a repulsion or an affinity with respect to the liquid can furthermore be applied to the substrate. However, this method is not suitable, during the self-assembly of the devices on the substrate, for compensating for large positional deviations between the desired target position and the position of the respective device directly after application, i. e. before the start of the assembly process. In particular, this method is not suitable, however, for reproducibly compensating for deviations with regard to the desired position of the midpoint and the desired rotational orientation of the device. Since the components furthermore only float on many of the liquids that can he used in this method, and do not sink in said liquids, incorrect positionings can occur, this being referred to as “tilt” in publications.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention docs not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of any previously described product, method of making the product, or process of using the product.

### SUMMARY OF THE INVENTION

Consequently, the problem addressed is that of providing a method which avoids the above indicated disadvantages. In particular, the problem addressed is that of providing a self-assembly method by which electrical, electronic and micromechanical components can self-assemble reproducibly on a substrate including the correction of large deviations with regard to the position of the midpoint and the rotational orientation of the component between desired position and position of the device after application on the substrate.

This problem is solved in the present case by means of a method for the self-assembly of at least one electrical, electronic or micromechanical component on a substrate, comprising the following steps: a) providing the substrate, b) applying an adhesive-repelling composition to at least one partial surface of the substrate which does not constitute a target position of the component, followed by a curing step, c) applying an adhesive composition to at least one partial surface of the substrate which constitutes a target position of the component, the partial surface of the substrate which is respectively provided with the adhesive-repelling composition enclosing and adjoining the partial surface of the substrate which is provided with the adhesive composition, and d) applying at least one component to a partial surface coated in accordance with b) or c), the adhesive-repelling composition being a radiation-curing adhesive coating compound. In order to achieve particularly good results, in this case the at least one component should be applied in such a way that it is positioned with at least one portion of its attachment area on a partial surface of the substrate coated in accordance with c).

Adhesive means sticking, adhering, attracting property of a surface. In this manner, pressure sensitive labels stick to many surfaces and protective film adheres to glass parts.

Abhesive is the antonym of adhesive (WO 2001/62489 (=US 2003-0113492) explains the word abhesive with “anti-adhesive”, see page 4 row 21), and is synonymous with non-sticky, repulsive or, especially in context with labels on release coatings, detachable.

A method for self-assembly within the meaning of the present invention should be understood to mean a method for positioning objects (here: electrical, electronic or micromechanical components) on a substrate which after the application of said objects on the substrate surface—presumably on account of an inhomogeneous distribution of the surface energy on or above the substrate—leads to an end positioning of the objects which is not induced externally in this case.

In this case, as already explained above, an electrical, electronic or micromechanical component should be understood to mean an, in particular small, building block which can be used in technical products and which can fulfil a technical function which, however, becomes technically usable only in association with other structures. A target position of a component within the meaning of the present invention should he understood to mean a partial surface of the substrate which substantially corresponds to the form of the attachment area of the component and is similar in size (i. c. deviates with regard to size by a factor of 0.8-3.0 from the attachment area of the device) and on which the component is intended to be situated after the assembly process.

An adhesive composition should be understood to mean in the present case a substantially non-metallic substance composition which is able to connect substrate and component by surface adhesion and internal strength (cohesion). With further preference, the adhesive composition is curable, i. e. that it can be cross-linked by suitable measures which are known per se to the person skilled in the art, thus resulting in a rigid compound that immobilizes the component on the substrate.

An adhesive-repelling composition is not spontaneously miscible with the adhesive composition and in contact with the latter leads to an increase in the contact angle (wetting angle) between substrate and adhesive composition. Such an adhesive-repelling composition is also referred to as “abhesive coating compound”. The adhesive-repelling composition used according to the invention is a radiation-curing abhesive coating compound, i. e. an abhesive coating compound having cross-linkable or polymerizable radicals which are curable by electromagnetic radiation, in particular UV light or electron beams. Consequently, the adhesive-repelling composition is cured by the composition applied to the substrate being irradiated with electromagnetic radiation, in particular UV light or electron beams, until at least partial curing of the composition is obtained.

### BRIEF DESCRIPTION OF THE DRAWINGS

FIG. 1 shows assembly of the adhesive drop depending on the distance between the applied drop and its target position;

FIG. 2 shows the adhesive form in the silicone resin frame;

FIG. 3 shows a visualization of the self-assembly; and

FIG. 4 is a graph showing assembly depending on the angle of rotation and distance from the target position.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

In the method according to the invention, the adhesive composition and the adhesive-repelling composition are applied to the substrate in such a way that the adhesive-repelling composition, after its curing, encloses and adjoins the adhesive composition after the application of the two compositions, i. e. that the cured adhesive-repelling composition surrounds the adhesive composition situated on the substrate in such a way that a phase boundary of the adhesive composition and of the cured adhesive-repelling composition is also present substantially at every location at which the contact angle between substrate and adhesive composition is formed.

In this case, the present invention not only solves the problems posed in the introduction but furthermore has the advantage that it can be implemented in a very simple manner, can be realized well by means of printing methods and can furthermore be integrated in a simple manner into automated methods for producing electrical and electronic products, in particular roll-to-roll methods. In this case, it furthermore also advantageously enables the use of flexible substrates. A further advantage is that, with a suitable choice of adhesive, the component floats into the adhesive (rather than only floating thereon) and, consequently; the component lies in a planar manner with respect to the substrate after assembly and, as a result, can thus be contact-connected in a particularly simple manner. It is furthermore advantageous that, by comparison with the methods above, the fault rate is lower, meaning that on average fewer assembly processes or a smaller number of components to be assembled are required in order to realize the assembly of components on substrates which leads to the products described in the introduction. Finally, in contrast to the methods described above, the present method can also be carried out in air.

It has surprisingly been observed that adhesive drops not positioned in an accurately targeted manner, as long as they impinge at least partly on a partial surface of the substrate which constitutes a target position of the component, move into the target position autonomously, i. e. without external influencing. This effect can be used in the application to operate the installation at higher speeds since the adhesive does not have to be positioned with such high precision.

The method according to the invention is preferably carried out in such a way that firstly the substrate is provided, than the adhesive-repelling composition is applied and cured, next the adhesive composition is applied and, finally, the at least one component is applied, i. e. that the chronological sequence of the individual method steps is preferably a)→b)→c)→d).

In order to enable particularly good self-assembly, the at least one component is preferably applied to the partial surface coated in accordance with b) or c) in such a way that at least one portion of its base area is already situated above its target position. Corresponding methods for this purpose are known, Applying the at least one component in step d) can preferably be effected by i) providing a supply having a multiplicity of electronic components at a delivery location for the electronic components, moving a part of the substrate which constitutes a target position of the component and is coated with the adhesive-repelling composition and the adhesive composition at least into the vicinity relative to the delivery location, contactlessly delivering one of the electronic devices from the delivery location while the partial surface of the substrate which constitutes a target position of the component is situated near the delivery location, such that after a free phase the electronic device at least partly touches the partial surface of the substrate which is provided with the adhesive composition, and iv) moving the partial surface of the substrate which is now provided with the component to a downstream processing location while the electronic device orients itself on the target position.

Particularly advantageously, the method for self-assembly can be carried out with a substrate composed of an elastic or plastically deformable material and with an electrically conductive patterning, the patterning having at least one path which is formed in a manner extending into the target position of the component, and the following steps being performed: i) implementing a perforation or weakening location in the region of the substrate around the target position of the component and around a part of the path of the patterning for the purpose of forming a flap containing the part of the path, raising the flap from the substrate, iii) folding over the flap in such a way that iv) a component situated on the flap makes contact with at least one part of the path of the patterning by means of at least one of the terminal contacts of said component. The components self-assembled according to this method are particularly protected on account of their embedding into the pocket formed by folding over the flap, with the result that particularly durable and stable electrical and electronic products and intermediate products result.

Preferably, the radiation-curing adhesive coating compound is a coating compound selected from the group comprising radiation-curing silicone resins (i.e. compositions substantially comprising polyalkyl-, polyaryl- and/or polyarylalkyl-siloxane polymers with or without free OH groups, if desired cocondensed with polyesters or polyacrylates, with radiation-curable side chains) and radiation-curing resins based on polyfluorinated alkyl (meth)acrylates or polyfluorooxyalkylene (meth)acrylates.

Radiation-curing resins based on polyfluorinated alkyl (meth)acrylates or polyfluorooxyalkylene (meth)acrylates which can preferably be used comprise cross-linkable coating compositions comprising 55-75% by weight of a polyethylenically unsaturated cross-linker, 20-40% by weight of at least one aliphatic acrylic ester and 1-20% by weight of at least one cross-linkable polyfluorinated alkyl (meth)acrylate or polyfluorooxyalkylene (meth)acrylate.

Furthermore, it has surprisingly been established that particularly precise phase boundaries which lead to a particularly pronounced increase in the contact angle of the adhesive composition and hence good self-assembly of the components at the target position can be obtained with radiation-curing silicone resins. With thermally curing silicone resins, in particular, satisfactory self-assembly cannot be obtained. The radiation-curing silicone resins are also preferred over radiation-curing resins based on polyfluorinated alkyl (meth)acrylates or polyfluorooxyalkylene (meth)acrylates.

The radiation-curing abhesive coating compound, in particular the radiation-curing silicone resin, preferably has radiation-curable side chains which are or contain (meth)acrylate radicals, epoxide radicals, vinyl ether radicals or vinyloxy groups. Particularly good results can be obtained if the radiation-curing abhesive coating compound comprises acrylate radicals.

Particularly good results can be obtained if the radiation-curing abhesive coating compound, in particular the radiation-curing silicone resin, has a viscosity of from 100 to 1500 mPa·s (viscosity defined by DIN 1342; measured at 25° C. according to DIN 53 019), particularly preferably 450-750 mPa·s. Examples of radiation-curing silicone resins that can be used by way of example are the silicone resins from Evonik Goldschmidt GmbH that are available under the trade name TEGOO RC 706, RC 708, RC 709, RC 711, RC 715, RC 719, RC 726, RC 902, RC 922, RC 1002, RC 1009, RC 1772, XP 8014, RC 1401, RC 1402, RC 1403, RC 1406, RC 1409, RC 1412, and RC 1422. The silicone resins TEGO® XP 8019 and TEGO® XP 8020 from Evonik Goldschmidt GmbH arc particularly suitable.

A photoinitiator, i. e. a substance which decomposes into reactive constituents under the action of electromagnetic radiation, for example, can furthermore be added to the adhesive-repelling composition, in particular the radiation-curing silicone resin, in order to improve the curing. In this case, free-radical photoinitiators decompose into free radicals under the influence of light. Corresponding photoinitiators may primarily originate from the chemical substance class of the benzophenone and are available under the trade names Irgacure® 651, Irgacure® 127, Irgacure® 907, Irgacure® 369, Irgacure® 784, Irgacure® 819, Darocure® 1173 (all from Ciba), Genocure® LTM, Genocure® MIRA or Genocure® MBF (from Rahn). The aromatic ketones available under the trade name TEGO® A17 and TEGO® A18 from Evonik Goldschmidt GmbH are preferably used as photoinitiator. Cationic photoinitiators form strong acids under the action of light and may originate primarily from the substance class of the sulphonium or iodonium compounds, in particular the aromatic sulphonium or aromatic iodonium compounds, and are available under the name Irgacure® 250 (from Ciba) for example. The cationic photoinitiator available under the trade name TEGOO PC 1466 from Evonik Goldschmidt GmbH is preferably used.

The proportion of the at least one photoinitiator in the adhesive-repelling composition, relative to the amount of radiation-curing silicone resin, is in this case preferably 0.1-15% by weight, preferably 2-4% by weight.

The adhesive composition to be used according to the invention can be, in principle, any adhesive composition which is able to permanently fix electrical, electronic or micromechanical components on substrate surfaces. Adhesive compositions that can preferably be used are epoxy, polyurethane, methacrylate, cyanacrylate or acrylate adhesives which can cure. In this case, epoxy adhesives are particularly preferred since they can cure thermally in a few seconds. Furthermore, acrylate adhesives are particularly preferred since they can cure very rapidly in a manner initiated by electromagnetic wave radiation.

Corresponding compositions are available under the trade name Monopox® AD VE 18507 from DELO Industrie Klebstoffe in Windach (epoxy adhesive) or RiteLok® UV011 from 3M (acrylate adhesive).

In this case, the employed viscosity of the adhesive should be as low as possible since the adhesive can then be processed as rapidly as possible and the self-assembly functions particularly well. Viscosities of 10-200 mPa·s (measured at 25° C. according to DIN 53 019) are preferred in this case.

The adhesive composition can additionally contain additives for increasing the electrical conductivity of the cured adhesive, in particular for producing an isotropic or anisotropic conductivity. These adhesives are preferably metal particles (in particular flakes, beads or platelets), metal nanowires, particles composed of metalized glass, metalized polymer beads or conductive organic polymers (in particular PEDOT:PSS, polyaniline and carbon nanowires, particularly based on graphite or graphene). The component can thereby also be electrically contact-connected besides the mechanical fixing.

In order to produce an isotropic conductivity, the proportion of the additives which increase the electrical conductivity of the cured adhesive is in this case preferably from 25 to 85% by weight, relative to the mass of the adhesive composition, with the proviso that a system above the percolation limit results. Corresponding measures as to how the person skilled in the art can determine the percolation limit of the system are commonly understood by those of ordinary skill in the art.

In order to produce an anisotropic conductivity; the proportion of the additives is from 5 to 20% by weight relative to the mass of the adhesive composition, with the proviso that a system below the percolation limit of the system results. In particular by adding corresponding particulate particles it is possible to equip the system in a form such that an anisotropic conductivity arises when the component is fixed. The component can thereby also be electrically contact-connected besides the mechanical fixing, without a short circuit arising between two spatially separate contacts.

The substrate that can be used according to the invention can be any substrate, in principle. Preferred substrates are films or laminates composed of polyethylene terephthalate (PET), polyimides (PI), polyethylene naphthalate (PEN), polybutylene terephthalate (PBT), polypropylene (PP), polyethylene (PE), polystyrenes (PS), polyamides (PA) or polyether ether ketone (PEEK) and the structure-reinforced composite materials based on these polymers.

Examples of commercially available substrates that can preferably be used are:

| Trade name | Manufacturer | Polymer type |
|---|---|---|
| Trogamid ® CX | Evonik Industries | PA |
| Teonex ® Q 51 | DuPont Teijin Films | PEN |
| Teonex ® (R) Q83 | DuPont Teijin Films | PEN |
| Kcmafoil ® HSPL 80 | Coveme | PET |
| Mclinex ® 504 st | DuPont Teijin Films | PET |
| Mclinex ® 723 | DuPont Teijin Films | PET |
| Mclincx ® 401 | DuPont Teijin Films | PET |
| Melinex ® 507 st | DuPont Teijin Films | PET |
| Kemafoil ® MTSL DY | Coveme | PET |
| Mylar ® A | DuPont Teijin Films | PET |
| Mylar ® ADS | DuPont Teijin Films | PET |
| Lumirror ® | Toray | PET |
| Hostaphan ® GN 50 4600 | Mitsubishi Polyesters | PET |
| Kemafoil ® HSPL 20 | Coveme | PET |
| Upilex ® 50 S | Ube Industries | PI |
| P84 | Evonik Industries | PI |
| Kapton ® 300 HV | DuPont Teijin Films | PI |
| Kapton ® 300 HPP-St | DuPont Teijin Films | PI |

Particularly preferably, the substrate used in the method is a PET film.

The amounts of adhesive and silicone resin that are to be used in order to obtain particularly good results are greatly dependent on the geometry of the components to be applied and thus also the size of the target position. It goes without saying that the frame itself can also be printed with different widths, such that the amount of printed silicone can be different for the same target position partial surface. The geometry of the partial surface of the substrate which does not constitute a target position of the component, in the same way as the geometry of the partial surface of the substrate which constitutes a target position of the component, need not necessarily be square and can also depend on the base area of the components to be applied. In particular, rectangular, hexagram-like or round geometries are also conceivable for both areas.

Particularly good results can be obtained if the area ratio of the partial surface of the substrate which does not constitute a target position of the component to the partial surface of the substrate which constitutes a target position of the component amounts to a value of 5-10 (determinable by means of the quotient of the two areas in μm²), preferably 7-9. For corresponding size ratios, given a target position in the form of a square base area having an edge length of 640 μm, an amount of silicone resin of 1-2 nl and an amount of adhesive of 5-50 nl are typically required.

Furthermore, the area ratio (determinable by means of the quotient of the two areas in μm²) of the partial surface of the substrate which constitutes a target position of the component to the attachment area of the component, i. e. the area which is oriented towards the substrate after assembly, is (determinable by means of the quotient of the two areas in μm²) preferably a value of 0.9-2.0, preferably 1.3-1.6, particularly preferably 1.4-1.5.

A further advantage of the present invention is, furthermore, that no corona treatment of the substrate has to be carried out in the method according to the invention since the adhesion of the silicone nevertheless suffices.

The present invention furthermore relates to the assembled electrical or electronic products which can be produced according to the method. In particular, the invention relates to an assembled RFID strap which can be produced by the method, or an assembled RFID label, having an RFID chip assembled on a substrate according to the method according to the invention.

The following examples are intended to elucidate the subject matter of the present invention in greater detail without restricting it to the exemplary embodiments.

### EXAMPLES

### Example 1

With a printing installation of the type EF 410 (from MPS) and a sleeve, a sleeve adapter and an air cylinder (from COE), an acrylate-modified radiation-curing silicone resin having a viscosity of 590 mPa·s measured at 25° C. (TEGO® XP 8019 from Evonik Industries) with 3% photoinitiator A17 (from Evonik Industries) on PET film (Mylar ADS, Dupon Teijin) was printed onto the substrate with the production of a plurality of silicone resin frames having a frame width of 300 μm around in each case a free inner square having an edge length of 640 μm not printed with silicone resin compound. Afterwards, in the same printing installation, a lamp rendered inert (the oxygen content was reduced to 50 ppm by supplying nitrogen), with ultraviolet radiation, was used to cure the silicone resin. The layer thickness of the silicone resin layer was 1 μm, which corresponds to an application weight of 1 g/m².

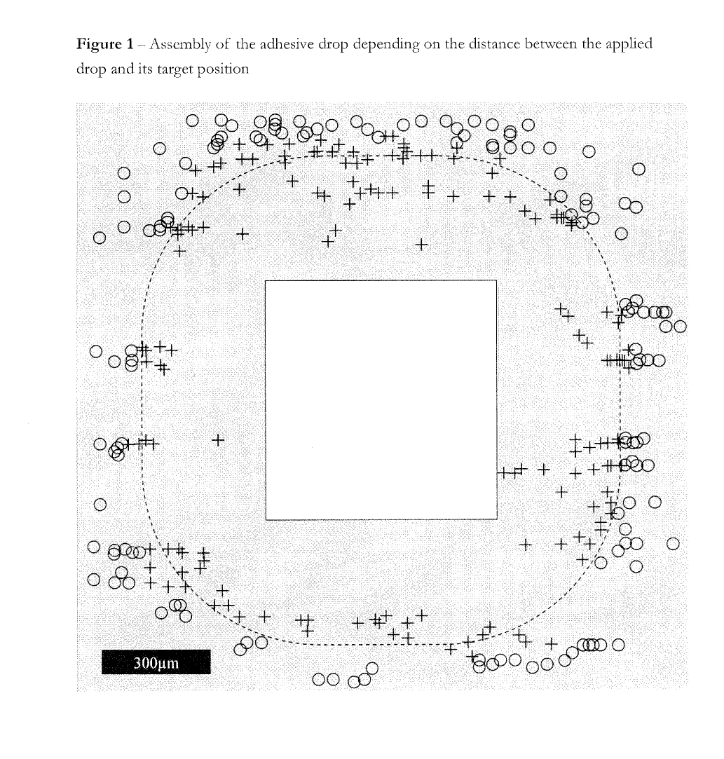

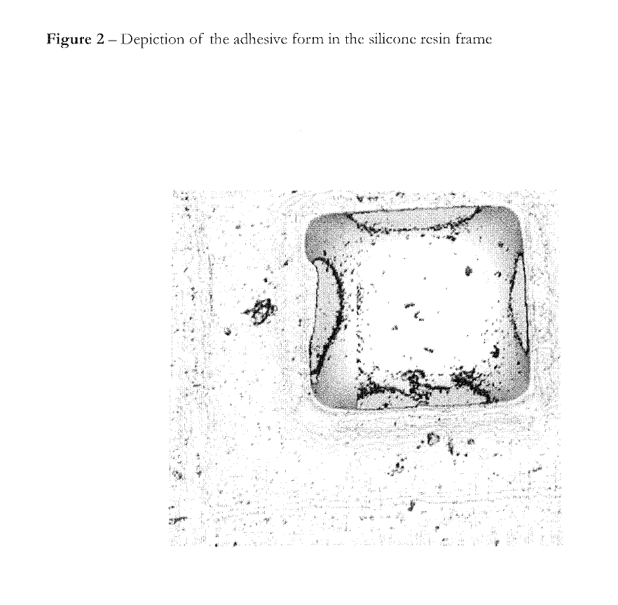

Subsequently, a drop of the adhesive Monopox® AD VE 18507 from DELO Industrie Klebstoffe having a volume of 17 nl was then applied in each case to different positions on the silicone frame or the inner square, in particular onto a position on the silicone frame near the inner square. It was observed here that the adhesive even then moves into the centre of the inner square as long as only part of the adhesive drop comes into contact with the inner square (cf. FIG. 1; “+”=movement of the drop to target position, “o”=no movement of the drop to target position). It was observed that the adhesive drop moves to the correct location—defined accurately to a few μm (<10 μm)—at the target position if it is metered onto an area of 1300·1300 μm² around the target position. This has the advantage that the application of the adhesive due to the silicone resin was able to be deposited at high speed and the adhesive is nevertheless seated precisely at the correct location in the desired form (cf. FIG. 2).

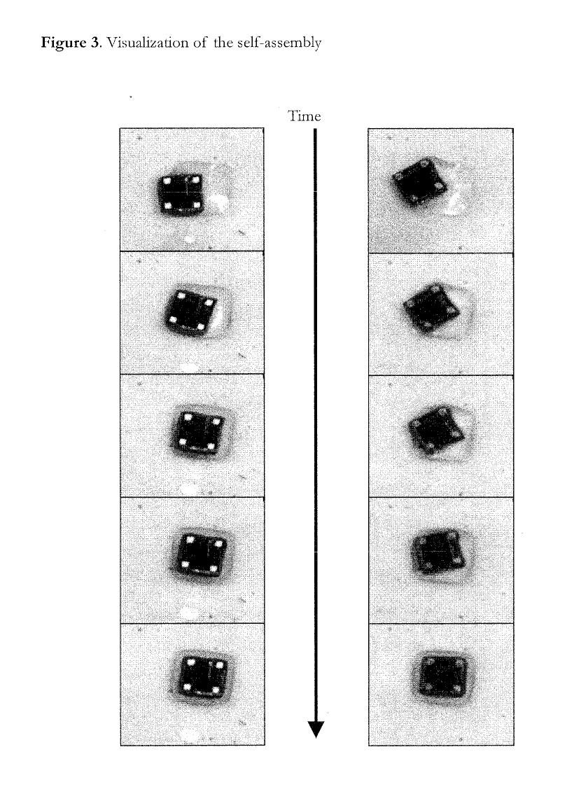

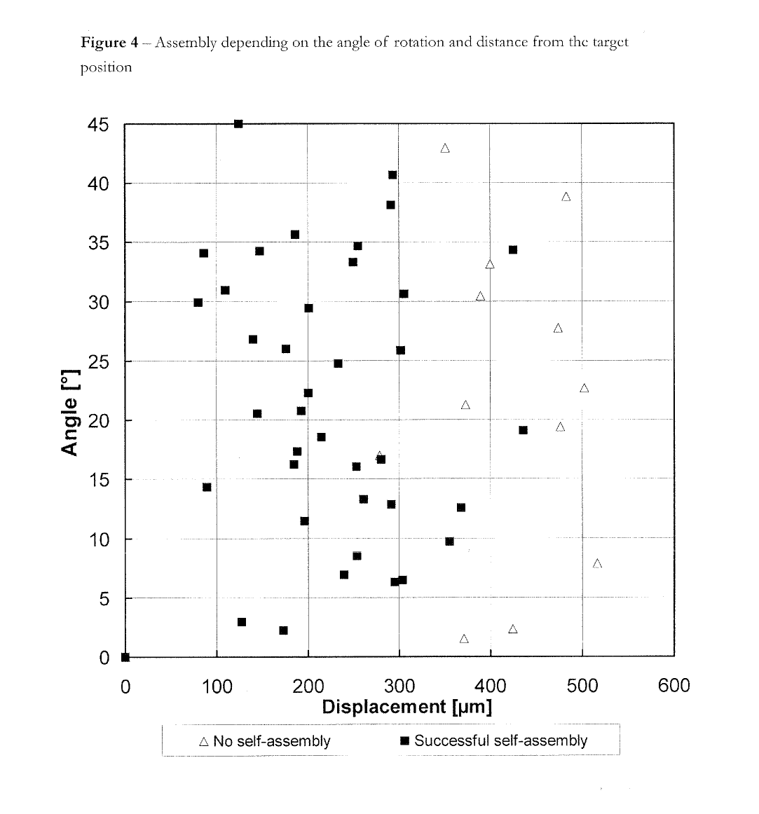

Square NXP Ucode G2XM SL31CS 1002 components having an edge length of approximately 440 μm, a height of approximately 150 μm and a weight of approximately 67 μg were introduced into these adhesive deposits having the square base. As a result of the self-assembling effect, chips that did not land in the correct position were pulled into the centre of the target region and a rotation was autonomously corrected (cf. FIGS. 3 and 4; successful orientations are depicted therein by dark squares, and unsuccessful orientation by light triangles).

The evaluation of the different landing positions revealed that the chip was reliably pulled into the centre of the target position as long as it does not exceed a distance (centre-centre) from the target position of 300 μm. The rotation was compensated for up to 45° (that is the definitional upper limit for the orientation of a square chip).

The orientation occurred in less than ten seconds while the substrate was at rest, depending on the distance from the target position. The orientation will occur faster in an installation that is not at rest, since the vibration of a moving installation accelerates the process.

### Example 2

Experiment as in Example 1, except that a printing plate from Reproflex was used for applying the structures.

### Example 3

Experiment as in Example 1, except that a canonically cross-linking silicone resin compound (TEGO® XP 8020) was used as the adhesive-repelling coating compound.

### Example 4

Experiment as in Example 2, except that a canonically cross-linking silicone resin compound (TEGO® XP 8020) was used as the adhesive-repelling coating compound.

### Example 5

Experiment as in Example 1, silicone resin frames having a width of 400 μm also being printed in addition.

### Example 6

Experiment as in Example 1 except that the adhesive RiteLok UV011 from 3M was used instead of the adhesive Monopox AD VE 18507 from DELO Industrie Klebstoffe. In this case, too, the chips oriented themselves, but a lower orientation speed was observed in comparison with Monopox AD VE 18507. In return, the adhesive can be cured by UV light in fractions of a second.

### Example 7

Experiment as in Example 6 except that a canonically curing silicone resin compound was used alongside the adhesive RiteLok UV011 from 3M. The orientation of the adhesive and of the chip functions in this combination as well.

### Example 8

Experiment as in Example 1, except that a silicone resin compound coloured red (TEGO® XP 8014) was used for better visibility. It has no adverse effect on the orientation.

### Example 9

Experiment as in Example 1, but different inner squares not covered with silicone resin compound were printed. With a ratio of chip size to inner square of from 0.9 to 2, the orientation is effected particularly reliably. The highest reliability with regard to centre-centre distance and compensation of rotation was observed at a ratio of 1.45.

### Example 10

Experiment as in Example 1, but different application weights of the silicone resin compound were applied. During subsequent testing by introducing adhesive drops of Monopox® AD VE 18507 from DELO Industrie Klebstoffe it was observed that the orientation behaviour is somewhat more reliable if the silicone resin compound is applied in a closed layer. In the experiments, closed structures were identified (observed through a coaxial microscope (CV-ST-mini type) from M-Service) starting from a weight per unit area of approximately 1 g/m² (measured using a twin-X X-ray fluorescence measuring instrument from Oxford instruments).

### Example 11

Experiment as in Example 1, but different intensities of corona pretreatment were used. It was established that the radiation-curing coating compounds exhibited good adhesion even on the substrates that have not been pretreated, and, consequently, this step can be obviated. In addition it was observed that the substrates without corona pretreatment exhibited more stable properties over the course of time and therefore have a better storage life.

### Example 12

Experiment as in Example 1, but larger chips (up to an edge length of 2 mm) were used. Even with larger chips, the orientation is reliably possible, particularly if the frame size of the adhesive-repelling coating compound is adapted to that of the chip. The ratio of inner square to chip size of approximately 1.45 as mentioned in Example 9 produced the best results in this case, too.

### Example 13

Experiment as in Example 1, but the frame was interrupted at some locations. This interruption can he used, for example, for connecting the chip to conductor tracks (for example with regard to sensors or tamper-evident inspection) by means of printing processes. The interruption does not impede the orientation behaviour as long as the part of the frame that was left free did not become too large in relation to the inner square. The maximum permissible interruption is dependent on the surface energy of the adhesive. With the use of Monopox® AD VE 18507 from DELO Industrie Klebstoffe, no adverse effect on the orientation behaviour was observed as long as the interruption was smaller than one tenth of the edge length of the inner square. The map of the capture radius of the adhesive as shown in FIG. 1 is influenced by the interruption, however. Drops that land in the vicinity of the interruption tend to orient themselves more poorly.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A method for the self-assembly of at least one electrical, electronic, or micromechanical component on a substrate, comprising the following steps:
a) providing the substrate;
b) applying an adhesive-repelling composition to at least a first partial surface of the substrate which does not constitute a target position of the component, followed by a curing step;
c) applying an adhesive composition to at least a second partial surface of the substrate which constitutes the target position of the component, where the first partial surface of the substrate which is provided with the adhesive-repelling composition encloses and adjoins the second partial surface of the substrate which is provided with the adhesive composition; and
d) applying at least one component to at least one of:
the first partial surface coated in accordance with b); and
the second partial surface coated in accordance with c);
wherein the adhesive-repelling composition is a radiation-curing abhesive coating compound.

2. The method according to claim 1;
wherein the temporal sequence of the individual method steps is a)→b)→c)→d).

3. The method according to claim 1;
wherein applying the at least one component in step d) comprises:
i) providing a supply having a multiplicity of electronic components at a delivery location for the electronic components;
ii) moving a part of the substrate which constitutes the target position of the component and is coated with the adhesive-repelling composition and the adhesive composition at least into a vicinity relative to the delivery location;
iii) contactlessly delivering one of the electronic devices from the delivery location while the partial surface of the substrate which constitutes the target position of the component is situated near the delivery location, such that a free phase the electronic device at least partly touches the partial surface of the substrate which is provided with the adhesive composition; and
iv) moving the partial surface of the substrate, which is now provided with the component, to a downstream processing location while the electronic device orients itself on the target position.

4. The method according to claim 3;
wherein the substrate is formed from an elastic or plastically deformable material;
wherein the substrate is provided with an electrically conductive patterning having at least one path which is formed in a manner extending into the target position of the component; and
wherein the method further includes the following steps;
i) implementing a perforation or weakening location in a region of the substrate around the target position of the component and around a part of the path of the patterning for the purpose of forming a flap containing the part of the path;
ii) raising the flap from the substrate; and
iii) folding over the flap in such a way that a component situated on the flap makes contact with at least one part of the path of the patterning by means of at least one of the terminal contacts of said component.

5. The method according to claim 1;
wherein the radiation-curing abhesive coating compound is a coating compound selected from the group comprising:
silicone resins; and
at least one polyfluorinated (meth)acrylate either on alkyl or alkylene basis.

6. The method according to claim 1;
wherein the radiation-curing abhesive coasting compound has radiation-curable side chains which are or contain at least one of:
(meth)acrylate radicals, epoxide radicals, vinyl ether radicals, and vinyloxy groups.

7. The method according to claim 1;
wherein the radiation-curing abhesive coating compound ahs a viscosity of from 100 to 1500 mPa·s measured at 25° C. according to DIN 53 019.

8. The method according to claim 1;
wherein the adhesive composition is a composition of at least one of:
an epoxy, polyurethane, methacrylate, cyanoacrylate, and acrylate adhesive.

9. The method according to claim 8;
wherein the viscosity of the adhesive composition is 10-200 mPa·s measure at 25° C. according to DIN 53 019.

10. The method according to claim 8;
wherein the adhesive composition has at least one additive selected from the group consisting essentially of:
metal particles, metal nanowires, particles composed of metalized glass, metalized polymer beads, and conductive organic polymers.

11. The method according to claim 1;
wherein the substrate is a film or a laminate composed of at least one of:
polyethylene terephthalate (PET), polyimides (PI), polyethylene naphthalate (PEN), polybutylene terephthalate (PBT), polypropylene (PP), polyethylene (PE), polystyrenes (PS), polyamides (PA), and polyether ether ketone (PEEK); or
wherein the substrate is a structure-reinforced composite material based on at least one of:
polyethylene terephthalate (PET), polyimides (PT), polyethylene naphthalate (PEN), polybutylene terephthalate (PBT), polypropylene (PP), polyethylene (PE), polystyrenes (PS), polyamides (PA), and polyether ether ketone (PEEK).

12. The method according to claim 1;
wherein an area ratio of the first partial surface of the substrate which does not constitute the target position of the component to the second partial surface of the substrate which constitutes the target position of the component amounts to a value of 5-10.

13. The method according to claim 1;
wherein a size ratio of the second partial surface of the substrate which constitutes the target position of the component to an attachment area of the component amounts to a value of 0.9-2.0.

14. An electrical or electronic product, comprising:
a component assembled on a substrate in accordance with
the method according to claim 1.
